(19) United States
(12) Patent Application Publication
(10) Pub. No.: US 2008/0216670 A1
(43) Pub. Date: Sep. 11, 2008

(54) Bakeware having a flexible member and method of manufacturing same

(76) Inventor: Troy Schuler, Rancho Cucamonga, CA (US)

Correspondence Address: BIRCH STEWART KOLASCH & BIRCH, PO BOX 747, FALLS CHURCH, VA, 22040-0747, US

(21) Appl. No.: 12/073,683

(22) Filed: Mar. 7, 2008

Related U.S. Application Data
(60) Provisional application No. 60/905,803, filed on Mar. 9, 2007.

(51) Int. Cl. A47J 36/00; A21B 5/00; B21D 53/00

(52) U.S. Cl. 99/427; 29/432.1; 29/436

(57) ABSTRACT

A method for assembling a bakeware having a metal frame and at least one flexible member is provided. The method includes forming a first hole in a metal sheet, forming a sidewall extending from the first hole, the sidewall having a lower lip, bending the sidewall and lower lip partially towards the metal sheet, placing a flexible member in the first hole, and pressing the sidewall and lower lip towards the metal sheet to secure the flexible member to the metal sheet. A bakeware including a metal frame and at least one flexible member is also provided.

### CROSS-REFERENCE TO A RELATED APPLICATION

This application claims the benefit of U.S. Provisional Application No. 60/905,803, filed Mar. 9, 2007, which is herein incorporated by reference in the entirety.

### BACKGROUND OF THE INVENTION

1. Field of the Invention

The present invention is directed generally to bakeware, and, more particularly, to bakeware having a flexible member and method of manufacturing the same.

2. Description of the Related Art

Conventional bakeware is typically formed of metal sheets that have been formed to define one or more cavities for receiving various ingredients for cooking. The one or more cavities may be integrally formed in the bakeware or they may be provided by attaching additional members. For example, a conventional muffin pan includes a metal frame and a plurality of metal cups attached to the metal frame using various welding techniques.

One drawback to bakeware made of metal sheets, it is often difficult to remove the product from the bakeware after cooking is complete. Recently, there have been attempts to make the receiving cavities out of flexible members, however, there have been no reliable means for attaching these flexible members to the metal frames.

### BRIEF SUMMARY OF THE INVENTION

In order to overcome one or more problems of the related art, and according to principles of this invention, a method for manufacturing bakeware having a flexible member is provided. The method includes forming a first hole in a metal sheet, forming a sidewall extending from the first hole, the sidewall having a lower lip, bending the sidewall and lower lip partially towards the metal sheet, placing a flexible member in the first hole, and pressing the sidewall and lower lip towards the metal sheet to secure the flexible member to the metal sheet.

In another aspect, forming the sidewall includes drawing down the sidewall from the first hole, and in the process of drawing down the sidewall the lower lip is formed.

In a further aspect, the flexible member may include a flexible rim, and the pressing the sidewall and lower lip presses the lower lip against the rim.

In another aspect, forming the first hole in the metal sheet may include punching the first hole in the metal sheet. Punching the first hole may include punching at least one additional hole. Placing the flexible member in the first hole may include placing an additional flexible member in the at least one additional hole.

In still another aspect, the flexible member may have one of a circular, rectangular, or square cross-section.

In yet another aspect, the method may further include forming a second hole having a shape different from the first hole, and securing a gripping member in the second hole.

According to principles of the present invention, a bakeware is also provided. The bakeware includes a metal frame having at least one hole formed therein, the metal frame including a sidewall drawn down from the at least one hole and having a lower lip extending towards the center of the at least one hole, and at least one flexible member, the flexible member being located in the at least one hole, the flexible member including a rim received by the lip, wherein the rim is held between the lower lip and the sidewall.

In another aspect, the at least one hole may include a plurality of holes, the at least one flexible member may include a plurality of flexible members, and each of the flexible members is located in a corresponding one of the plurality of holes.

In yet another aspect, the flexible member may have one of a circular, rectangular, or square cross-section.

In still another aspect, the bakeware may further include a gripping member located in the metal frame.

In a different aspect, the flexible member may be formed of a silicone material

In another aspect, the bakeware may be one of a muffin pan, a bread pan, and a cake pan.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

### BRIEF DESCRIPTION OF THE DRAWINGS

The present invention will become more fully understood from the detailed description given hereinbelow and the accompanying drawings and photographs which are given by way of illustration only, and thus are not limitative of the present invention and wherein:

FIG. 1 is a bakeware according to a first exemplary embodiment of the invention;

FIG. 2 is a bakeware according to a second exemplary embodiment of the invention;

FIG. 3 is a bakeware according to a third exemplary embodiment of the invention;

FIG. 4 is a bakeware according to a fourth exemplary embodiment of the invention;

FIG. 5 is a bakeware according to a fifth exemplary embodiment of the invention;

FIG. 6 is a flow diagram showing the steps of manufacturing the bakeware of FIG. 1;

FIGS. 7A and 7B show the flexible cup and gripping member, respectively, before being attached to form the bakeware of FIG. 1; and

FIGS. 8A-8L show the assembly of the bakeware through the various steps of manufacturing of FIG. 6.

### DETAILED DESCRIPTION OF THE INVENTION

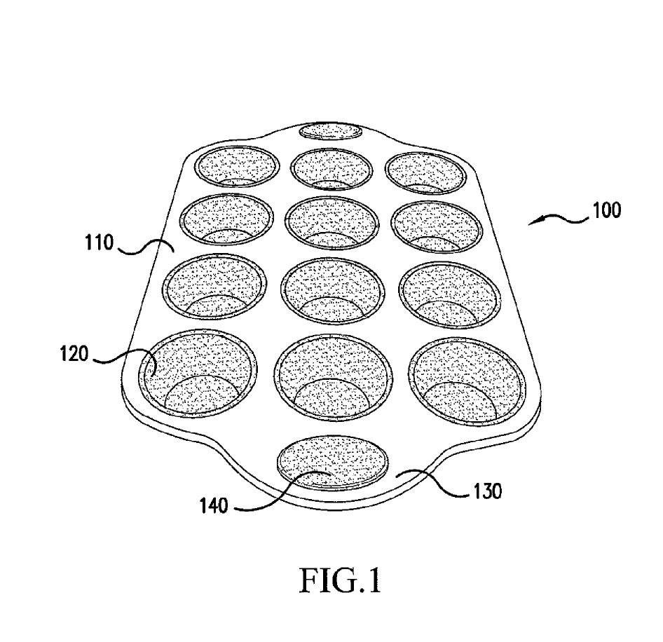

As shown in FIG. 1, a first exemplary bakeware 100 is in the form of a muffin pan that includes a metal frame 110 and a plurality of flexible members or cups 120 attached to the metal frame 110. Each of the flexible cups 120 is preferably formed of a flexible material that has a melting point greater than typical baking temperatures. For example, the flexible material may be a silicone material or compound.

While each of the flexible cups 120 has a circular cross-section, flexible cups having other cross-sections, such as, square or rectangular, may also be provided. The bakeware may also include handle portions 130 with gripping members 140. The gripping members 140 may be formed of the same material as the flexible cups 120 or from different materials, so long as they too have a melting point greater than typical baking temperatures. It is also understood that bakeware 100 can be formed without handle portions 130 and/or gripping portions 140, if so desired.

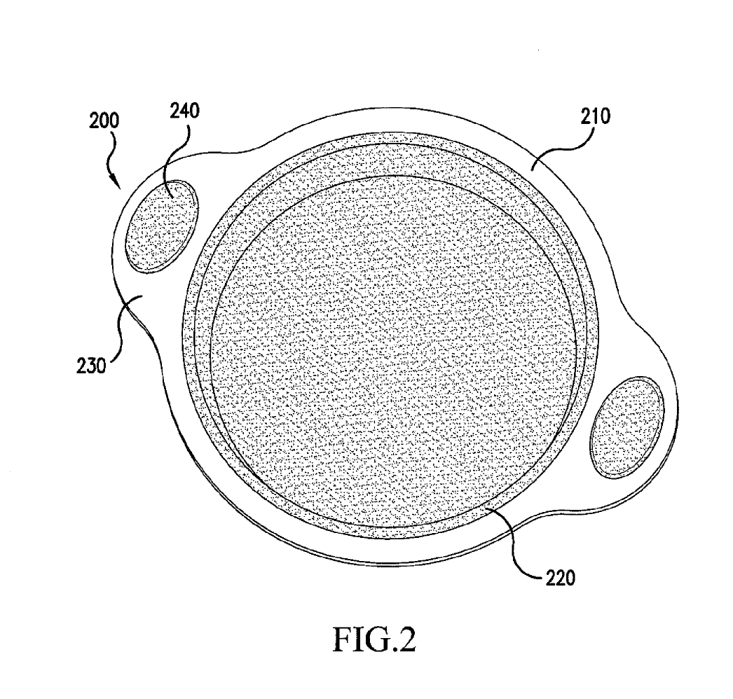

As shown in FIG. 2, a second exemplary bakeware 200 is in the form of a cake pan that includes a metal frame 210 and a large flexible member 220 attached to the metal frame 210. The bakeware may also include handle portions 230 with gripping members 240.

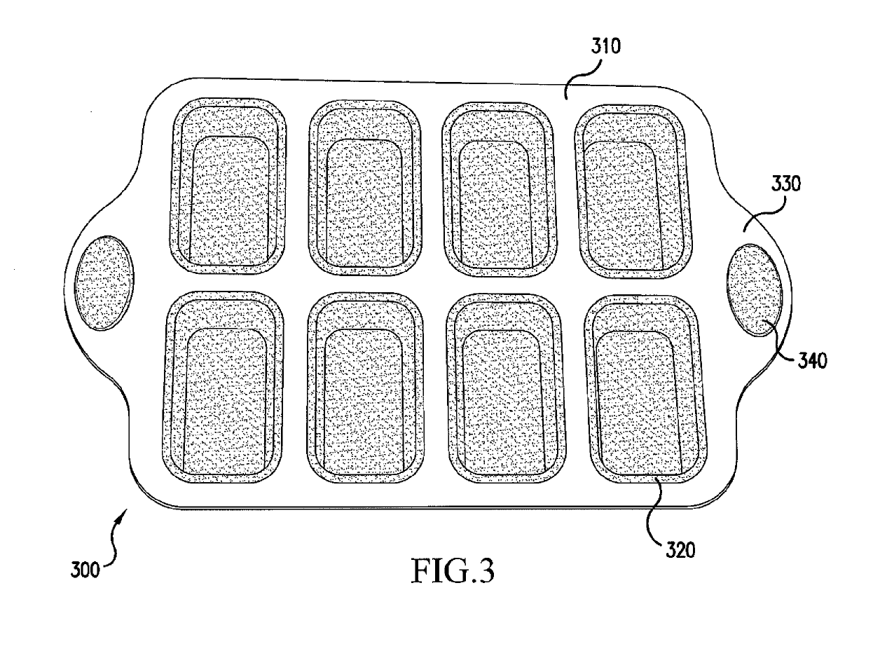

As shown in FIG. 3, a third exemplary silicone/metal bakeware 300 is in the form of a bread pan that includes a metal frame 310 and a plurality of flexible cups 320 attached to the metal frame 310. The bakeware 300 may also include handle portions 330 with gripping members 340.

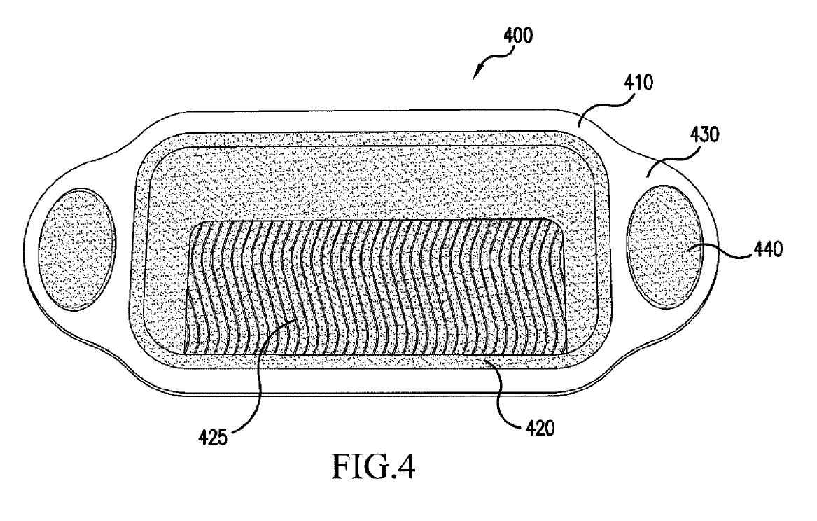

As shown in FIG. 4, a fourth exemplary bakeware 400 is in the form of a large bread pan that includes a metal frame 410 and a single rectangular flexible cup 420 attached to the metal frame 410. In this exemplary embodiment, the bottom surface 425 of the flexible cup 420 includes a plurality of undulations. The bakeware 400 may also include handle portions 430 with gripping members 440.

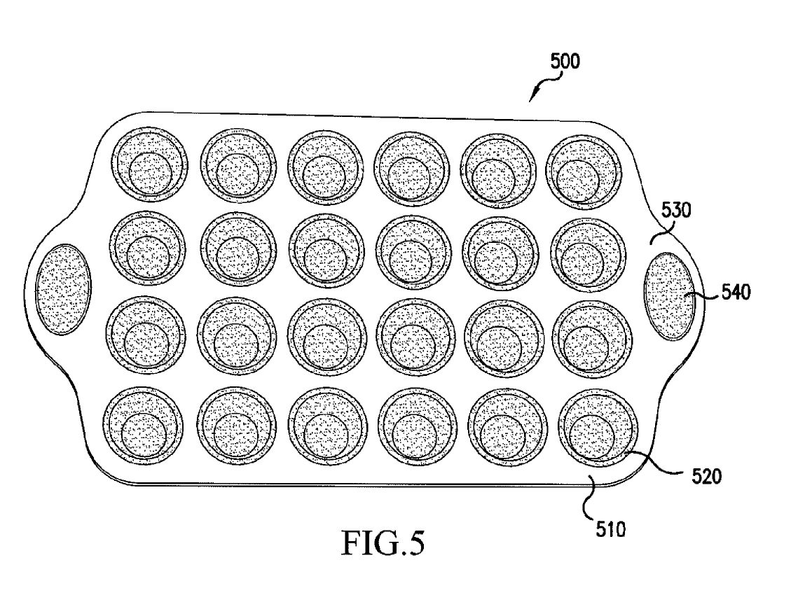

As shown in FIG. 5, a fifth exemplary bakeware 500 is in the form of a muffing pan similar to muffin pan 100 above. The bakeware 500 includes a metal frame 510 and a plurality of flexible cups 520 attached to the metal frame 510. The bakeware 500 may also include handle portions 530 with gripping members 540.

As clear from comparing FIG. 5 and FIG. 1, the number of flexible cups of the bakeware depends on the size of the metal frame and the size of the flexible cups. In addition, the flexible cups may be formed with a matte finish, a smooth finish, or a combination finish. Depending on the finish selected, one or more cooking properties can be controlled, such as evenness of cooking and ease of release from the bakeware. Furthermore, the flexible cups may be black, grey, white, or other suitable colors depending on the desired cooking properties.

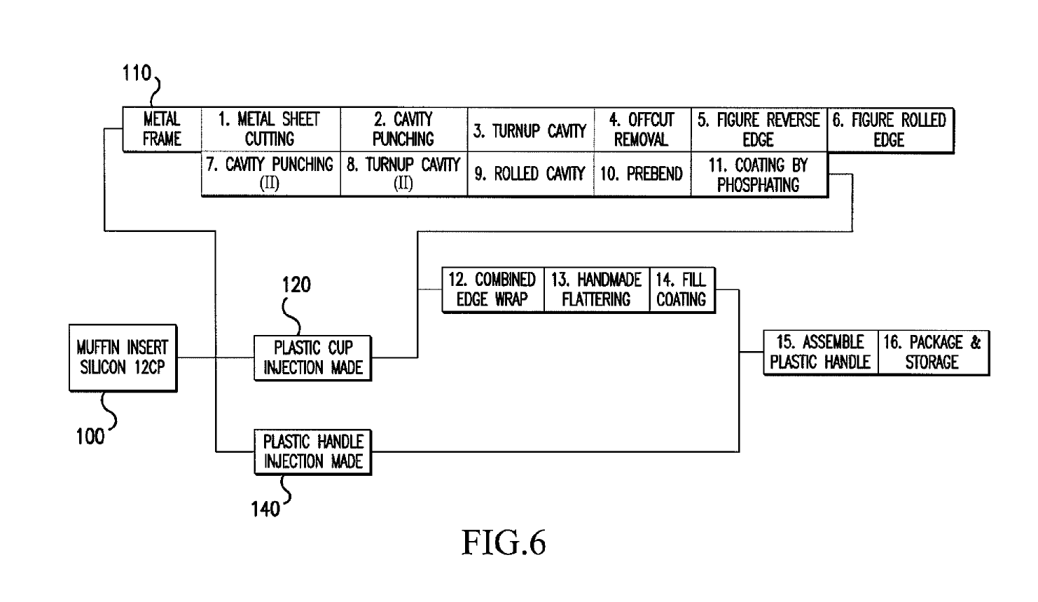

Each of the flexible cup(s) described above are attached to the corresponding metal frame using similar techniques. FIG. 6 shows a flow chart of an exemplary method of manufacturing the bakeware 100. This method can be used to produce each of the exemplary bakewares above.

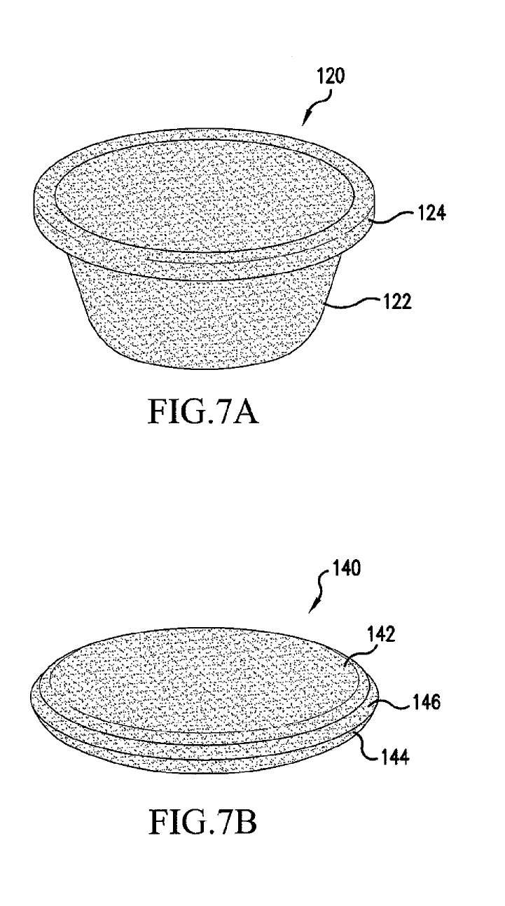

As shown in FIG. 6, there are three components to the bakeware 100. The first component is the frame or pan body 110. The second component is/are the flexible member(s) 120, in this case, a plurality of flexible cups, which is shown in FIG. 7A. The third component is/are the gripping member(s) 140. The flexible member 120 and gripping member 140 are formed by injection molding using conventional techniques.

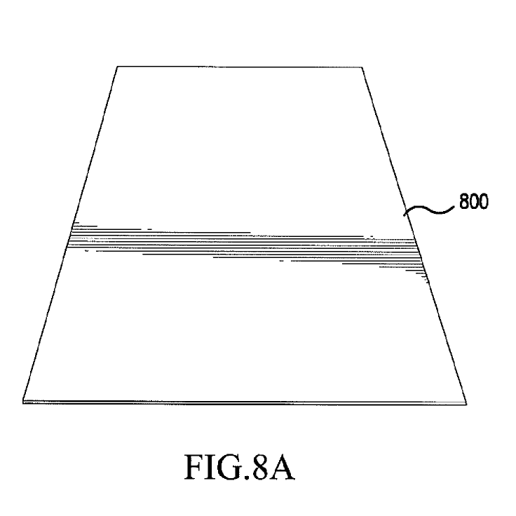

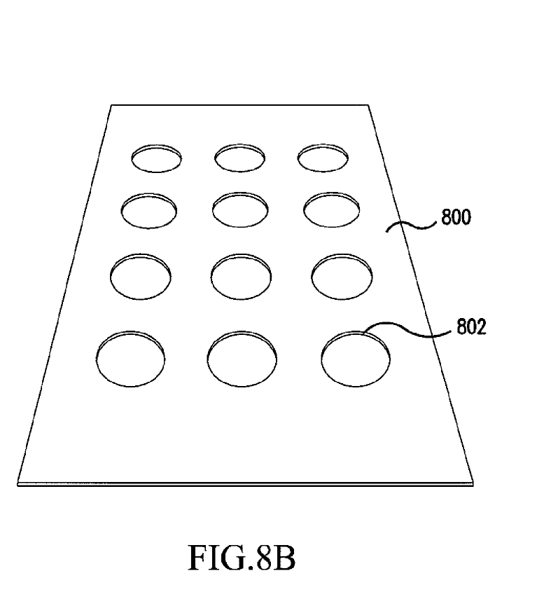

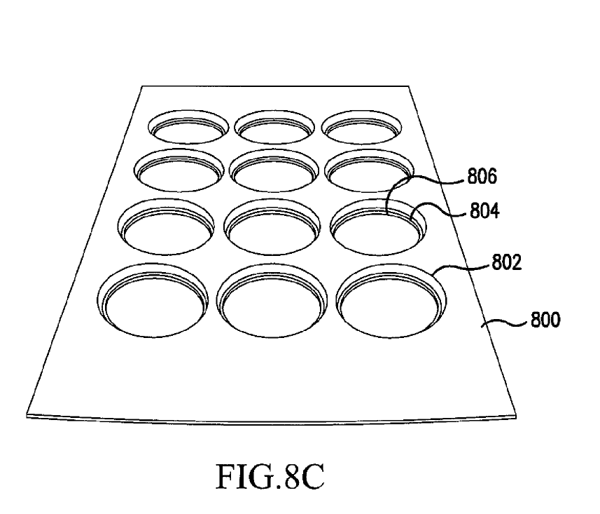

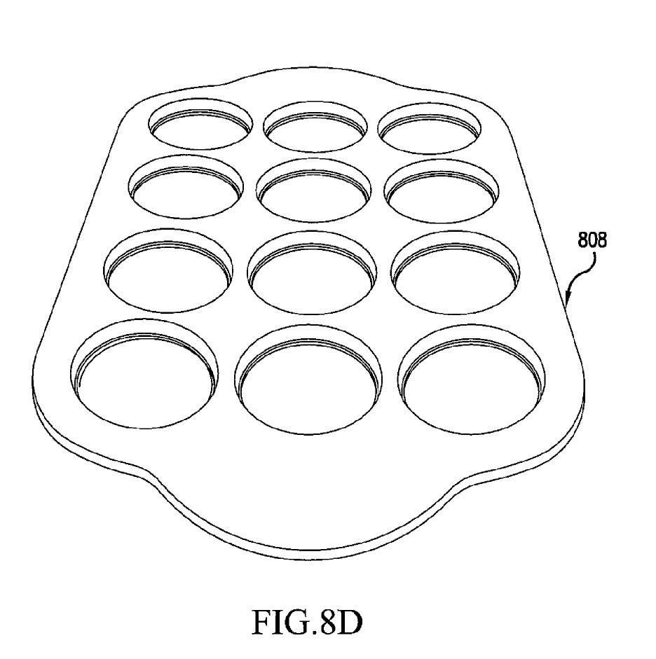

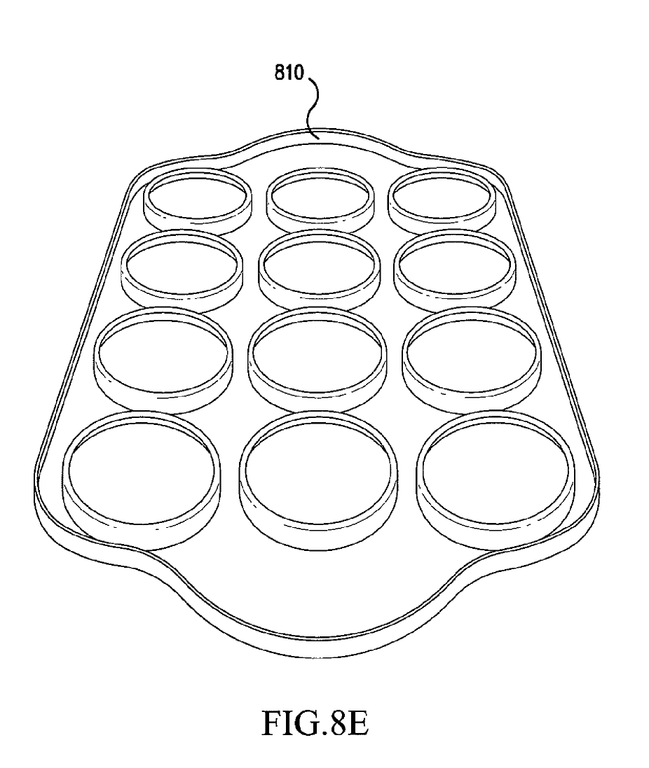

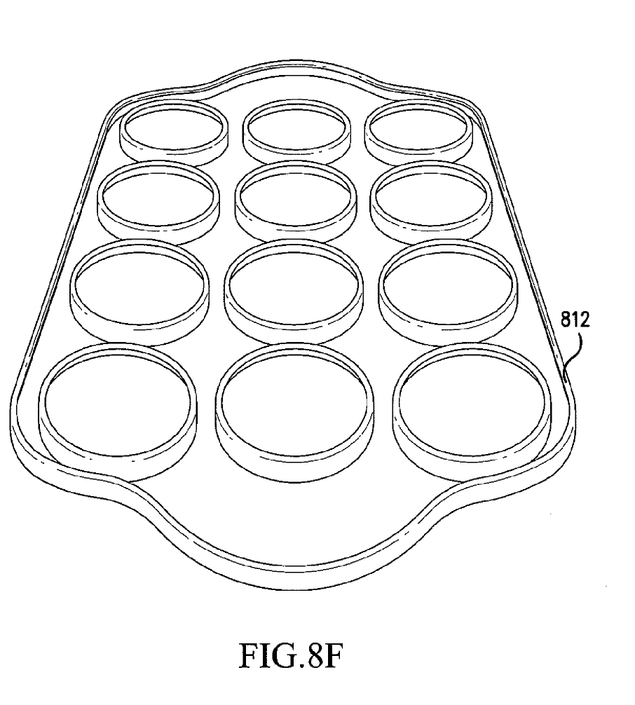

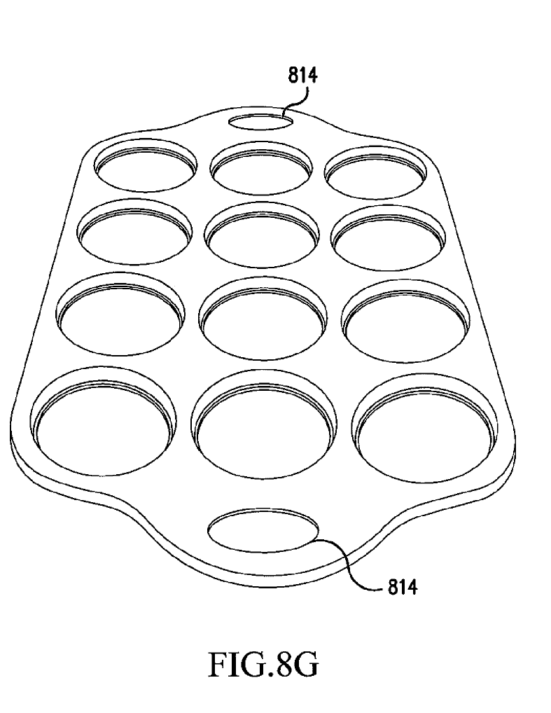

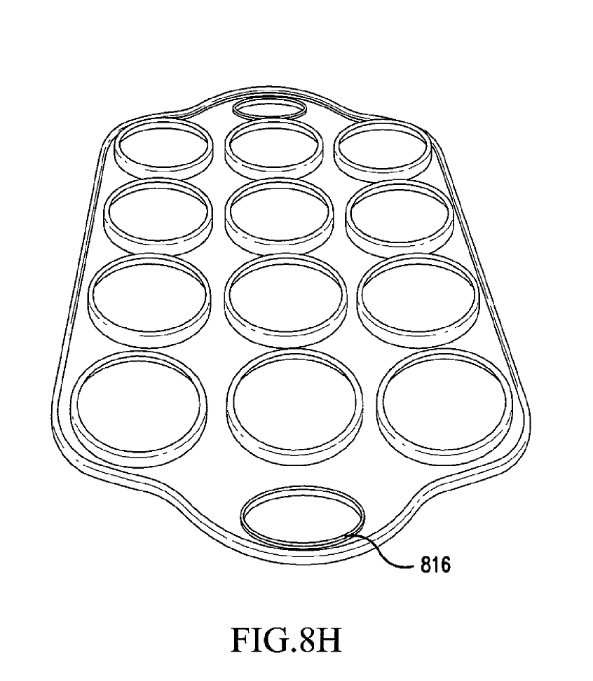

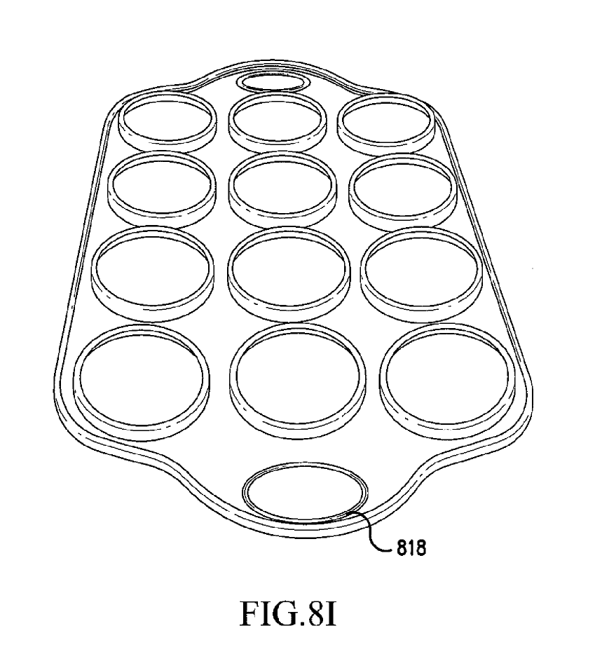

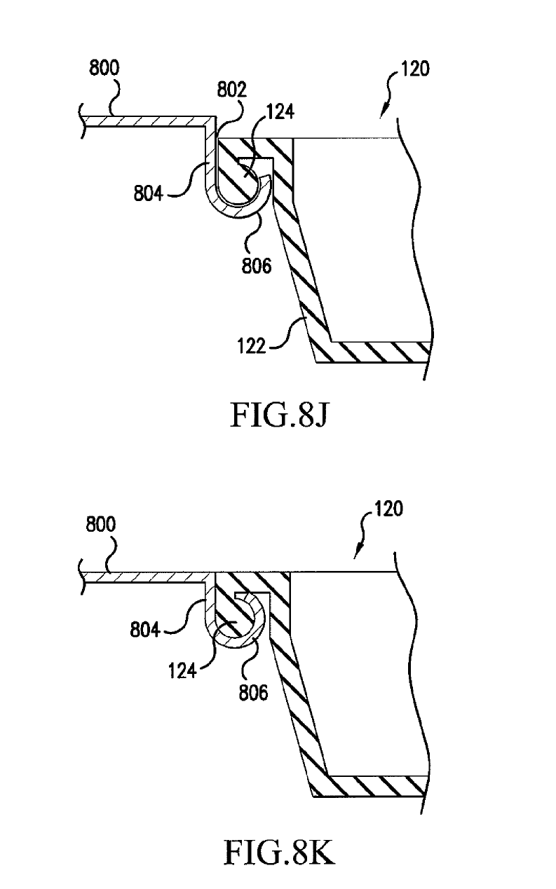

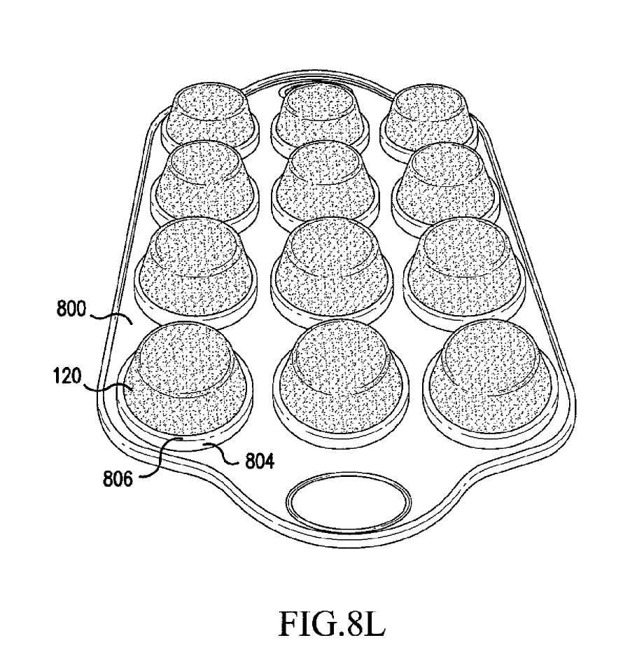

As shown in FIG. 7A, the flexible member 120 includes a flexible body 122 and a flexible rim 124. The flexible rim 124 extends downward from the top of the flexible member a predetermined distance for reasons that will be described below. The gripping member 140 includes a top portion 142 and a lower portion 144 separated by a groove 146. Having described the flexible member 120 and gripping member 140, the formation of the frame 110 and assembly of the bakeware will be described with reference to FIGS. 6 and 8A-8N.

As shown in FIG. 8A, the metal frame 110 is formed from a metal sheet 800. Preferably, the metal sheet 800 is formed of steel. The metal sheet 800 may be cut from a larger metal sheet or formed from metal sheets pre-cut to standard sizes. Next, one or more holes 802 are formed in the metal sheet, such as by cavity punching or other conventional techniques, as shown in FIG. 8B. Then the metal sheet 800 is draw down from the plurality of holes 802 to provide sidewalls 804 as shown in FIG. 8C. The ends of the drawn down sidewalls 804 are turned up to form a lower lip 806, also shown in FIG. 8C. It is the sidewall 804 and the lower lip 806 that will be used to hold the individual flexible cups 120, as described in more detail below.

After the lower lip 806 has been formed, the metal sheet 800 may then be cut to remove any excess metal from the metal sheet 800 to start defining the outer shape of the metal frame 110 via a cut edge 808 as shown in FIG. 8D. The cut edge 808 is turned downwards as shown in FIG. 8E to define a sidewall 810. The cut edge 808 of the sidewall 810 may then be folded or rolled over to provide a smooth edge 812 as shown in FIG. 8F. The smooth edge protects a user's hands from contacting the sharp cut edge 808.

As shown in FIG. 8G, a plurality of holes 814 are formed in the metal sheet 800 using a punch in the area which will form the handle portions 130 of the metal frame 110. The holes 814 are then drawn down to form sidewalls 816 and then folded or rolled over to provide a smooth edge 818 as shown in FIGS. 8H and 8I. The smooth edge 818 will be used to secure the gripping members 140 to the metal frame as described below.

After forming the smooth edge 818, the sidewall 804 and lower lip 806 are pre-bent a certain amount, as shown in FIG. 8J, such that when the flexible cup 120 is placed therein, the sidewall 804 and lower lip 806 supports the flexible rim 124 of the flexible cup 120. After the pre-bending, but prior to placing the flexible cup 120 onto the lower lip 806, the metal sheet 800 may be treated by phosphating to convert the surface of the metal sheet 800 to iron phosphate, if desired. Next, the flexible cup(s) 120 are placed in the metal sheet 800 and supported by the lower lip 806.

Then the sidewall 804 and lower lip 806 are pressed towards the metal sheet 800. Because of the pre-bend of the sidewall 804 and the lower lip 806, the sidewall 804 and lower lip curl inwards on themselves and engage the rim 124 of the flexible cup 120 as shown in FIG. 8K to secure the flexible cup 120 to the metal sheet 800. While the rim 124 has been shown with a specific shape in FIGS. 8J and 8K, it is understood that many different shapes may be provided so long as the rim 124 extends downward from the top of the flexible cup 120.

A fill coating may be applied to the sidewall 804 and lower lip 806 to hide any markings made during the pressing on the sidewall 804 and lower lip 806 as shown in FIG. 8N. Finally, the gripping members 140 are inserted into the holes 814, such that the smooth edge 818 fits into the groove 146 of the handle to provide the bakeware of FIG. 1.

While the above method of manufacturing bakeware 100 was set out in a specific order, it is understood that order of assembly may be varied so long as the sidewall 804 and lower lip 806 are formed prior to placing the flexible cup 120 into the metal sheet 800. For example, the fill coating may be applied prior to the sidewall 804 and lower lip 806 is pressed towards the metal sheet 800. Generally, the coating material should have sufficient flexibility/malleability when it is applied to the metal surface so as to not be damaged by the final pressing of the sidewall 804 and lower lip 806 towards the metal sheet 800 to crimp the flexible cup. It is also understood that the method described above is intended to be exemplary and not limited to just the specific manufacturing steps described above. For example, the holes 802 may be provided by cutting the metal sheet 800 rather than punching.

The invention thus being described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed:

1. A method for manufacturing a bakeware having a metal frame and at least one flexible member, the method comprising:
forming a first hole in a metal sheet;
forming a sidewall extending from the first hole, the sidewall having a lower lip;
bending the sidewall and lower lip partially towards the metal sheet;
placing a flexible member in the first hole; and
pressing the sidewall and lower lip towards the metal sheet to secure the flexible member to the metal sheet.

2. The method according to claim 1, wherein forming the sidewall includes drawing down the sidewall from the first hole, wherein in the process of drawing down the sidewall the lower lip is formed.

3. The method according to claim 2, wherein the flexible member includes a flexible rim, and the pressing the sidewall and lower lip presses the lower lip against the rim.

4. The method according to claim 3, wherein forming the first hole in the metal sheet includes punching the first hole in the metal sheet.

5. The method according to claim 4, wherein punching the first hole includes punching at least one additional hole.

6. The method according to claim 5, wherein placing the flexible member in the first hole includes placing an additional flexible member in the at least one additional hole.

7. The method according to claim 1, wherein the flexible member has one of a circular, rectangular, or square cross-section.

8. The method according to claim 1, further comprising:
forming a second hole having a shape different from the first hole; and
securing a gripping member in the second hole.

9. A bakeware comprising:
a metal frame having at least one hole formed therein, the metal frame including a sidewall drawn down from the at least one hole and having a lower lip extending towards the center of the at least one hole; and
at least one flexible member, the flexible member being located in the at least one hole, the flexible member including a rim received by the lip, wherein the rim is held between the lower lip and the sidewall.

10. The bakeware according to claim 9, wherein the at least one hole includes a plurality of holes, the at least one flexible member includes a plurality of flexible members, and each of the flexible members being located in a corresponding one of the plurality of holes.

11. The bakeware according to claim 9, wherein the flexible member has one of a circular, rectangular, or square cross-section.

12. The bakeware according claim 9, further comprising a gripping member located in the metal frame.

13. The bakeware according to claim 9, wherein the flexible member is formed of a silicone material.

14. The bakeware according to claim 9, wherein the bakeware is one of a muffin pan, a bread pan, and a cake pan.
